(19) United States
(12) Patent Application Publication
(10) Pub. No.: US 2009/0315341 A1
(43) Pub. Date: Dec. 24, 2009

(54) Door lock

(76) Inventor: Robert L. Willcox, Owasso, OK (US)

Correspondence Address: ROBERT E. MASSA, 1535 SOUTH MEMORIAL DRIVE, SUITE 102, TULSA, OK, 74112-7046, US

(21) Appl. No.: 12/214,821

(22) Filed: Jun. 23, 2008

(51) Int. Cl. E05C 1/00

(52) U.S. Cl. 292/163

(57) ABSTRACT

A bolt mountable on adjacent members of a structure having a bolt assembly mountable on a first member of said structure and a keeper assembly mountable on a second member of said structure. A slide bolt is positioned to move slidably in a first channel in a slide block of bolt assembly which is aligned between the bolt assembly the keeper assembly to provide locking operation with a locking pin depending thru the keeper and is controllable from above keeper. The slide block includes a second channel in longitudinal connection with first channel, but not having entire lengthwise communication with the first channel in order to provide for compressibility. A coil spring is positioned in the second to react with the slide bolt, and a retainer depends from near one end of the slide bolt to provide compressibility for the coil as the slide bolt is locked. Upon release of the locking pin, the compressive force of the coil spring against the retainer forces the slide bolt to open forcefully,

### FIELD OF THE INVENTION

My invention relates to safety bolts. More particularly, my invention relates to safety bolts to hold adjacent members in a secure or locked position. Still more particularly, my invention relates to safety bolts positionable upon the surface of adjacent members for holding the members secure, the safety bolts actuable only from the side of the adjacent members upon which the safety bolts are placed.

### BACKGROUND OF THE INVENTION

Locking devices for doors have been known for at least four thousand years, and probably originated in the Near East, where early forms of wooden locks operated by keys have been found in Egypt. Since this early period, the term lock has referred to a fastening device which included a bolt movable into a secure position by a key.

Eventually, because of improved technology, the term lock has become broader in meaning to encompass a fastening, as for a door, box, trunk lid, drawer, etc., in which a bolt is secured by any of various cooperating mechanisms and can be released by inserting and turning a key or by operating a special device, such as a combination, timing clock, automatic release button, magnetic solenoid, or other means.

Thus, a bolt may be best exemplified as a bar which is movable within a guide attached to a door to permit an end of the bar to fit into a fixed socket, or keeper, on an adjacent door jamb. Usually, a bolt is constructed so that the entire operating structure may be mounted on the surface of the door, lid, drawer, or other movable apparatus which requires securing or protection.

A typical bolt is intended to be controlled from just one side of a closure, as for example, the interior side of a house door. Too frequently, only a few small wood screws are provided for holding the bolt in place on a door where security is desired. Consequently, an intruder may simply force the door open easily without exerting a great deal of force, because the small wood screws are easily dislocated and because the door jamb is usually a weak structure.

The closest prior art to my improved lock invention is the patent to my earlier invention, shown in U.S. Pat. No. 4,746,152.

The earlier prior art describes numerous bolt and lock devices, such as those found in the following U.S. Pat. No. 43,145, Warner, Jun. 14, 1864, U.S. Pat. No. 188,134, Hill, Mar. 6, 1877, U.S. Pat. No. 257,141, Purves, Apr. 25, 1882, U.S. Pat. No. 284,519, Warren, Sep. 4, 1883, U.S. Pat. No. 291,352, Jewett, Jan. 1, 1884, U.S. Pat. No. 995,232, Edgar, Sr., Jun. 13, 1911, U.S. Pat. No. 1,015,338, Peel, Jan. 23, 1912, U.S. Pat. No. 1,086,365, Hendren, Feb. 10, 1914, U.S. Pat. No. 1,159,877, Smith, Nov. 9, 1915, U.S. Pat. No. 1,364,757, Herman, Jan. 4, 1921, U.S. Pat. No. 1,410,841, Simpson, Mar. 28, 1922, U.S. Pat. No. 1,520,509, Rancour, May 10, 1922, U.S. Pat. No. 1,617,813, Judge, Feb. 15, 1927, U.S. Pat. No. 3,264,018, Honvener, Aug. 2, 1966, U.S. Pat. No. 3,918,752, Leone et al. Nov. 11, 1975, U.S. Pat. No. 4,021,063, Porter, May 3, 1977, U.S. Pat. No. 4,341,408, Blevins, Jul. 27, 1982.

### SUMMARY OF THE INVENTION

The primary object of my invention is to provide a bolt which is sturdy, strong, and yet simple in construction and easy to use.

Another object of my invention is to provide a bolt which is of unique construction and lockably secure in a convenient and efficient manner.

Still another object of my invention is to provide a bolt which is easily maneuverable into and out of a locking condition with minimum effort.

Still another object of my invention is to provide a bolt which is easily applicable to various types of closure members.

Then, still another object of my invention is to provide a strong and secure lock which will clearly establish a sense of assured safety to the owner by the effect of the forceful movement.

Still another object of my invention is to provide a strong, secure lock which has the innate quality of indicating a locked or unlocked condition, capable of being assessed from a distance.

I have described my current invention to show as much detail as possible relating to my previous patent device to attempt to emphasize the benefits of my improved invention and be able to show clearly those benefits.

I have been associated with the building and construction business for a long time, and consequently I am aware that the construction methods and materials prevalent in homes and offices have in recent times given us rather inadequate security in these areas.

For example, in the construction of homes, door locks are installed on weak doors and door jambs with only a few short wood screws. The bolt member of the customary door lock enters the keeper for only a short distance, and the keeper itself is situated within a thin portion of the door jamb. A sharp blow, as by a kick or sudden push may easily open most doors.

Even when a dead bolt is used in addition to the regular lock, the same low resistance to force is present because, again, the keeper of the dead bolt is set within the weak door jamb. Of course, when a dead bolt is used in addition to the conventional door lock, the force required to break open the door is increased, but is still not great.

A typical bolt which is mounted on the interior surface of a door will provide even less security because usually the keeper portion of such a lock is held on the door jamb by a few wood screws and, in this arrangement, the screws are in line with the direction of the force which can be applied to the exterior of the door in forcing the door open.

A simple key lock may be easily opened from outside a door by someone who has good knowledge of locks and the proper equipment. More complicated key locks might present difficulty for the less experienced person.

Then, bolts, as I use the term to refer to locking devices which have a slide bolt member which moves into locking position within a keeper, are mounted on an interior side of a door, window, or the like, and are not operable by a key, and will usually be more resistant to furtive opening from the exterior.

With the knowledge I have gained from experience in the construction industry, I have designed a bolt which, by my experimentation and testing, is greatly resistant to force applied to the outer surface of a door while my bolt is in a locking position.

I have accomplished this advantage, most importantly, by designing a bolt which completely by-passes the door jamb. I have designed my bolt so that one component of the bolt, for example, the keeper assembly portion, is mounted on a solid portion of the door, and another component, for example, the bolt assembly, is mounted on a solid portion of the door frame, completely beyond the door jamb. In other words, in one manner of mounting, the bolt assembly is positioned on the wall farther from the edge of the door than the door jamb.

I have also designed my bolt so that either assembly, either the bolt assembly or the keeper assembly may be mounted on the door or the wall, as the installer chooses, or as the structure of the door requires. Also, my bolt may be mounted on either a right-hand door or a left-hand door, whichever position is required.

My bolt is intended, primarily, to give security to a resident or a family while he or they are within the premises, since the bolt is lockable from the interior, and not capable of being locked from the exterior.

However, I wish to emphasize that my bolt is not restricted to use as a door bolt. There are other uses for my bolt. For instance, a small version is completely adaptable as a bolt for a window.

My bolt may be used on certain types of sliding doors, folding doors, drawers, or other structures where a bolt may hold two adjacent members securely.

My bolt is of simple design, provides a secure lock, is attractive, and can be finished in a style to coincide with existing decor.

I have developed my bolt assembly in two operating assemblies, what I have referred to above as a bolt assembly and a keeper assembly.

The bolt assembly includes an elongated slide bolt movable within a groove formed between a basic member, which I refer to as a slide block, mounted on a first of a pair of adjacent members, and a cooperating enclosing member, which I refer to as a slide plate. The slide bolt has a locking pin opening at one end which is capable of receiving and holding securely a locking pin operable within the keeper assembly which is mounted securely on the second of a pair of adjacent members.

The locking operation is accomplished by means of the slidable movement of the slide bolt from its position within the bolt assembly into the keeper assembly where it is then held in a secure locking position by cooperation of a locking pin into an opening in the end of the slide bolt by the force of a coil spring against the locking pin.

A pair of shoulders at the end of the slide bolt define a narrow channel or passageway communicating with the locking pin opening, allowing a narrow stem connected axially to the locking pin to pass through the passageway.

The keeper assembly includes a basic member which I refer to as a button block upon which there is mounted a cooperating member which I refer to as a button plate. The button block and the button plate cooperate to form a groove in alignment with the groove in the bolt assembly for slidable movement of the slide bolt. The button block has a hole therein essentially at a right angle to the position of the slide bolt and formed to receive therein the locking pin. Also, the hole contains a spring member placed beneath the locking pin to urge the locking pin toward the outer side of the keeper assembly as it is mounted.

Depression of the locking pin into the hole in the keeper assembly causes the narrow stem to be moved into alignment with the narrow channel of the slide bolt so that the slide bolt may move into position directly over the depressed locking pin. Then, release of the pressure against the narrow stem and locking pin permits the locking pin to be urged upwardly into the locking pin opening where it is held securely.

Parallel to and communicable to the slide bolt channel, a compression spring moves in a channel to direct the slide bolt to an open position when lock is open thru action against a retainer depending from an end of slide bolt into the channel adjacent the compression spring.

Then, in my improved invention the manual movement of my lock from a closed position to an open position is forcefully aided by the release of the coil spring compression of the amended slide bolt.

The above objects and advantages of my invention will become apparent from my description of the following preferred embodiments of my invention.

### BRIEF DESCRIPTIONS OF THE DRAWINGS

FIG. 1 is a perspective view of a bolt according to my invention showing the bolt in a locking position.

FIG. 2 is a side view of a bolt according to my invention showing the bolt components in a slightly spaced position to provide a better view for clarity.

FIG. 2A is a sectional view of a bolt along the lines 2A-2A of FIG. 2.

FIG. 3 is a top view of a bolt according to my invention showing the operating components in phantom for better clarity.

FIG. 4 is an exploded view, in perspective, of a bolt according to my invention showing various components in typical relationship.

### DESCRIPTION OF THE PREFERRED EMBODIMENTS

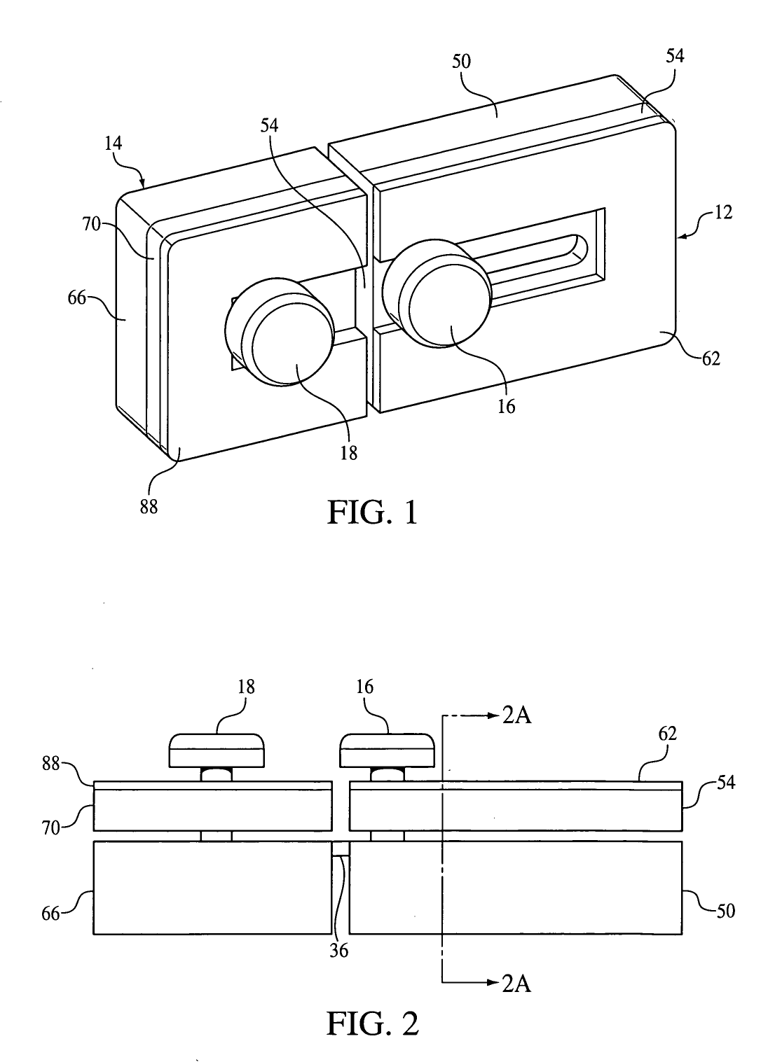

FIG. 1 is a perspective view of a bolt 10, generally, according to my invention, as it would appear in a locked position. My bolt device 10, generally, comprises a bolt assembly 12, generally, and a keeper assembly 14, generally, which cooperate to perform a locking operation.

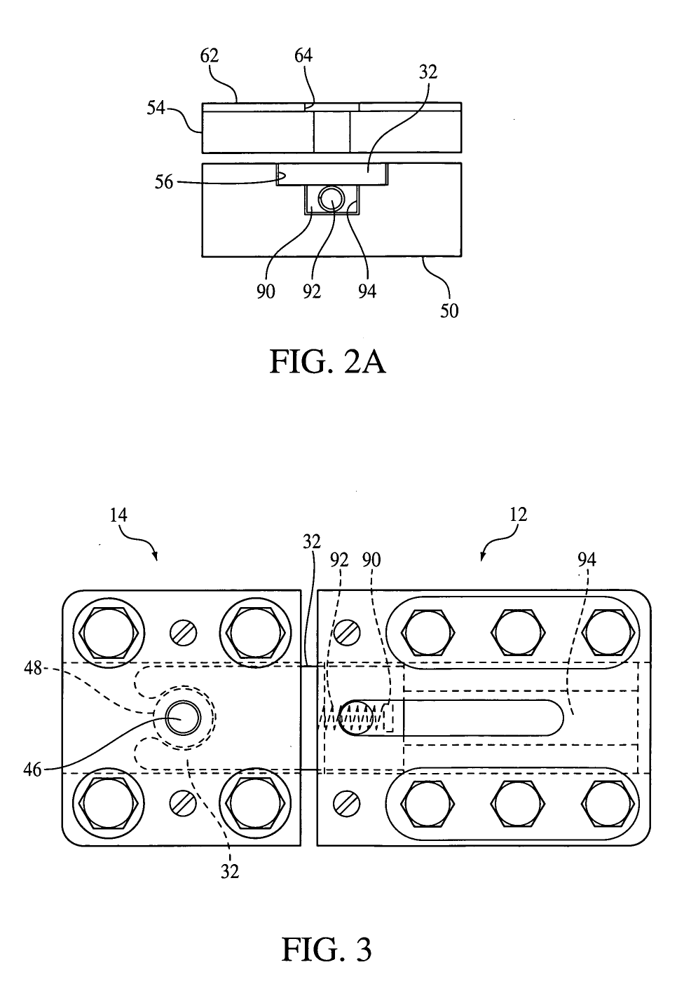

I have especially designed my bolt to have two special features which are clearly evident in FIGS. 1 and 2. That is, the condition of the bolt, as being either locked or unlocked, may be clearly seen by someone at a considerable distance from the bolt; if the bolt is used in securing the door of a house, this condition may be easily determined from across the room. Also, the bolt 10 may be easily placed in a locked or unlocked condition by using just one hand. As part of the bolt assembly 12, a slide bolt button 16 provides the external means by which a slide bolt on the interior may be moved into and out of a locking condition in cooperation with a locking pin which is depressible by force applied to locking pin button 18.

Components in my prior U.S. Pat. No. 4,746,152, bearing the numbers 20 thru c0, were eliminated from the current drawings as not being essential for the proper understanding of this improvement, and, also for easier understanding of this improvement.

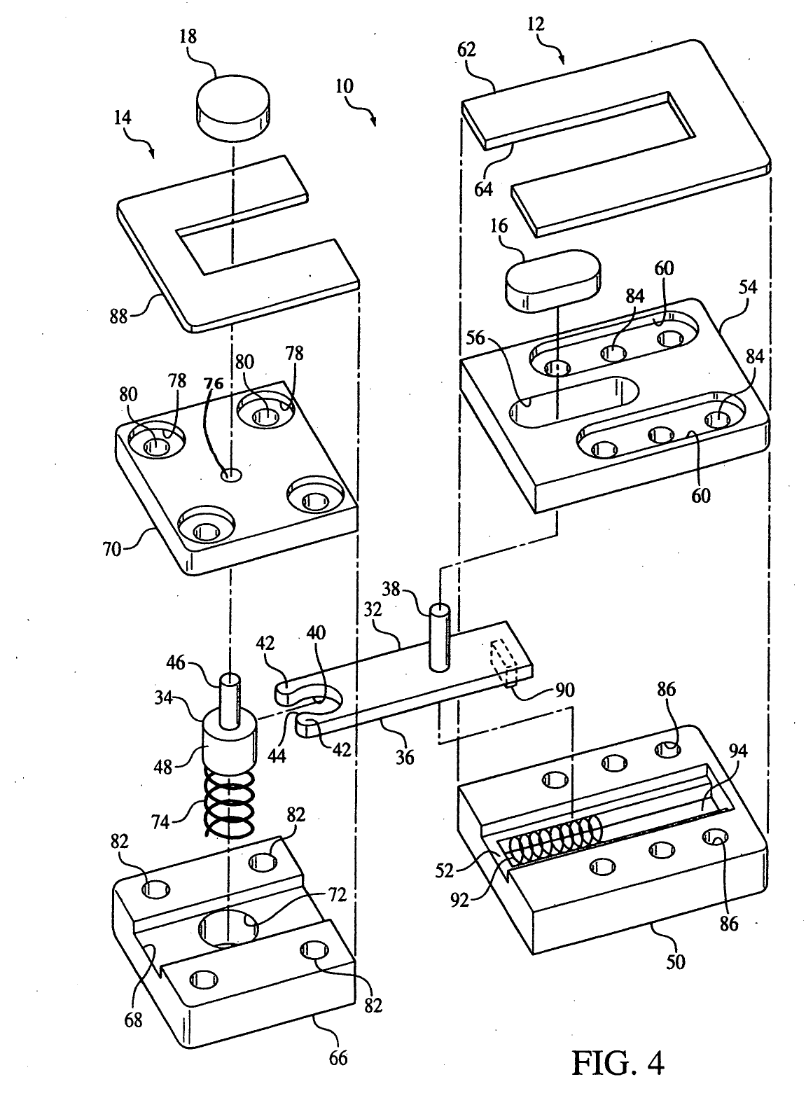

FIG. 4 shows the geometry of the various components and their relationship with each other.

The locking operation of my bolt is performed by the cooperation of a slide bolt 32, generally, with a locking pin 34, generally. I have shown in FIG. 4 the slide bolt 32 to be an elongated, flat member 36 with a slide bolt control stem 38 near a first end and a locking pin opening 40 adjacent a second end. A pair of shoulders 42 at the second end are spaced apart a suitable distance to define a narrow passageway 44 communicating with the locking pin opening 40. The passageway 44 is slightly larger than the diameter of a stem 46 positioned axially on locking pin 34, but smaller than a pin portion 48 of locking 34, generally. In a locked position, pin portion 48 is held securely within locking pin open 40. Most conveniently, the locking pin opening 40 and the locking pin portion 48 are cylindrical.

The bolt assembly 12, generally, includes a slide block 50 which, in this embodiment, includes a recess of channel 52 longitudinally thereof in which the slide bolt 32, generally, is positioned for slidable movement.

A slide plate 54 is positionable upon the slide block 50 to cooperate with the slide block 50 in providing a recess or tunnel for control of the movement of the slide bolt 32, generally. In this version I have shown a channel 52 in the slide block 50 and a flat lower surface of slide plate 54 which form the recess for the slide bolt 32, generally.

Slide plate 54 has a narrow, longitudinal groove or slot 56 to receive therethrough the control stem 38 by means of which the slide bolt 32, generally, may be manually moved slidably within the bolt assembly 12 to a locked position. The button 16 is secured to stem 38 for ease of handling.

Slide plate 54 has recesses 60 in the upper side so that lag screws may be mounted in a manner that upper surfaces of the heads of the screws are flush with or below the upper surface of the slide plate 54. A flat top cover 62 is positionable upon the slide plate 54 for decorative purposes by any suitable means, such as adhesive means or by a circumferential clamp, and includes a central slot 64 to accommodate movement of the control stem 38.

The keeper assembly 14, generally, comprises a button block 66 which I have shown as having a channel 68 in alignment with the channel 52 of the slide block 50, to receive a portion of the slide bolt 38 for locking. A button plate 70 is mounted upon the button block 66 for cooperation with button block 66 in providing a recess for the further movement of slide bolt 32, generally, and containment of the locking components. Thus, button block 66 includes an opening 72 into which a spring member 74 is positioned beneath pin 48 in a manner to urge locking pin 34 upwards against the lower surface of button plate 70. Button plate 70 includes an opening 76 therethrough which permits stem 46 to pass through to the exterior to be capped by button 18.

As I mentioned above with respect to the channel 52, the channel 68 may be formed in the same type of cooperation between button block 66 and button plate 70. The proper recess may be formed in any suitable cooperation between these components.

Button plate 70 includes recesses 78 around each hole 80 for lag screws to permit the upper surface of lag screws to be flush with or below the surface of button plate 70. Holes 80 are in alignment with 82 in the button block 66 for lag screws for secure mounting of the button assembly 14. Then, similarly, slide plate 54 has openings 84 in alignment with holes 86 in slide block 50, for lag screws for secure mounting.

A top cover 88 is mountable on button plate 70 by any convenient means as with top cover 62.

With my improvement in my invention, I have arranged for the first and second channels which accommodate means for the positioning and operationing for a coil spring and the slide bolt.

In my previous invention, shown in my U.S. Pat. No. 4,746,152 patent, I had described in the drawings thereof, the structure of slide bolt 32, is necessary in that invention for the movement and control of the locking system for my original lock.

For instance, that particular structure required the slide bolt button 16 and control stem 38 to be positioned on the upper side of the slide bolt, and did not require any of the mechanism to be positioned on the lower side of the slide bolt.

In my improved invention, I have positioned a retainer member 90 on the lower side of the slide bolt 32 to act as a stop and as a compressing member for the spring member 92 which is positioned in the spring channel 94.

In the “open” position of the lock, the second spring 92 is resting in an uncompressed condition in the second channel 94.

In the “closed” or “locked” position, the second spring 92 is compressed against a wall portion 96 of the channel 94 of the slide block 50.

Then, when the locking pin 34 is actuated to open the lock, the second spring 92 is suddenly released and the slide bolt 32 is quickly forced open. In a metallic version of the lock, this movement makes a loud noise as the metallic components clash.

With a steel lock, people who have tested it say that the loud noise made by this opening of the lock seems to give them an added sense of confidence and security in the strength of the lock even though it occurs during an opening movement.

Since many different embodiments of my invention may be made without departing from the spirit and scope thereof, it is to be understood that the specific embodiments described in detail herein are not to be taken in a limiting-sense, since the scope of my invention is best defined by the appended claims.

I claim:

1. A bolt mountable on adjacent members of a structure to hold the members lockably secure, comprising:
a bolt assembly mountable on a first member of the adjacent members, including
a slide block having a channel for a slide bolt,
a slide bolt movable slidably in said channel and having a control stem near a first end and a locking pin at a second end, and
a keeper assembly mountable upon a second member of adjacent members, comprising:
a button block having a channel in alignment with channel in slide block, and having an opening to receive said pin for locking operation,
wherein the bolt further comprises:
a spring channel in the slide block extending communicably adjacent to and parallel to said slide bolt channel,
a spring member positionable in said spring channel, and
slide bolt includes a retainer depending therefrom to be accessible within said spring channel in a manner to compress the spring positioned therein when said slide bolt is placed in a locking position.

2. A bolt as described in claim 1, wherein:
the spring channel adjacent to the slide bolt channel is slightly narrower than the slide bolt channel.

3. A bolt as described in claim 2, wherein:
the spring channel adjacent to the slide bolt channel is slightly narrower than the slide bolt channel.

4. A bolt as described in claim 3, wherein:
the retainer is positionable against an end of the coil spring in order to compress the coil spring when the bolt is in a locking position.

5. A bolt as described in claim 4, wherein:
the spring channel is confined by wall members structured near opposite sides of the slide block.
